(19) United States
(12) Patent Application Publication
(10) Pub. No.: US 2024/0033157 A1
(43) Pub. Date: Feb. 1, 2024

(54) LOW-PROFILE ACTUATORS FOR ASSISTIVE WEARABLE DEVICES

(71) Applicant: X Development LLC, Mountain View, CA (US)

(72) Inventor: Antonio Raymond Papania-Davis, Oakland, CA (US)

(21) Appl. No.: 17/874,088

(22) Filed: Jul. 26, 2022

(51) Int. Cl. A61H 1/02; A61H 3/00; B25J 9/00

(52) U.S. Cl. CPC A61H 1/0237; A61H 3/00; B25J 9/0006; A61H 2003/007; A61H 2201/1207

(57) ABSTRACT

This application relates to an actuator for an assistive device that includes: an upper and a lower attachment portion, a first drive pulley coupled to the upper attachment portion and having a first diameter, a second drive pulley coupled to the upper attachment portion and having a second diameter that is smaller than the first diameter, an idler pulley coupled to the lower attachment portion, and a belt that forms a loop by extending from the first drive pulley, around the idler pulley, and onto the second drive pulley, where activating a motor to rotate in a first direction causes the belt to be wound onto the first drive pulley and off the second drive pulley, and activating the motor to rotate in a second direction causes the belt to be wound off the first drive pulley and onto the second drive pulley.

### TECHNICAL FIELD

This disclosure relates to actuation systems for assistive wearable devices such as exoskeletons.

### BACKGROUND

Exoskeletons are wearable devices that are typically designed to assist a wearer with movement, for example, by providing force, stability, and balance to supplement a wearer's own capabilities. Exoskeletons can enhance the function of different joints in the body, such as an ankle, a knee, or an elbow. For example, an exoskeleton can include an actuator configured to transmit torque to the joint in order to actuate it.

### SUMMARY

This specification describes actuation systems for exoskeletons and other wearable assistive devices. For example, the actuation systems can use multiple mechanically-linked pulley drums, with each pulley drum having a separate axis of rotation, to selectively apply force to actuate a joint of a wearer's body.

The pulley drums of the actuation system can allow for highly customizable transmission ratios without gears. For example, the drive ratio for the drums can be set by selecting an appropriate radius of a first drive pulley drum relative to a second drive pulley drum. The actuation system also allows for significantly more freedom in the design of the actuation system. Accordingly, the actuation system can be applicable to different joints of a wearer's upper and lower body, and it can accommodate different body types and force delivery requirements.

The actuation system can include a motor that is housed in the first drive pulley drum, and the second drive pulley drum can be coupled to the motor through a mechanical linkage that is configured to rotate the second drive pulley drum. For example, a transmission belt can couple the two pulley drums so that when the motor rotates the first drive pulley drum, the transmission belt also rotates the second drive pulley drum. The two pulley drums and the motor components can be placed at one side of the joint to be actuated (e.g., above the wearer's ankle). The actuation system can further include an idler pulley drum that can be placed at the other side of the joint (e.g., at or below the wearer's ankle). The first drive pulley drum, the second drive pulley drum, and the idler pulley drum, can be connected by a main belt that can form a loop by extending from the first drive pulley drum, around the idler pulley drum, and onto the second drive pulley drum. The main belt can be arranged so that activating the motor to rotate in a first direction can cause the main belt to be wound onto the first drive pulley drum and to be wound off the second drive pulley drum. Similarly, activating the motor to rotate in a second direction (e.g., a direction opposite to the first direction) can cause the main belt to be wound off the first drive pulley drum and to be wound onto the second drive pulley drum.

The characteristics of the pulley drums can set a desired transmission ratio, which causes the first and second drive pulley drums to unequally wrap material of the main belt as the motor is actuated. For example, in some implementations, the portions of the first and second drive pulleys that receive the belt have different diameters, causing a single turn of each belt to wrap on a different length of the main belt. In other implementations, the mechanical linkage and the portions of the first and second drive pulleys that engage it have different diameters, so that a single rotation of the motor results in a differential number of turns of the first and second drive pulleys, which also results in a different length of the main belt to be wrapped on the first and second drive pulleys. Due to the differential winding of the main belt on the first and second drive pulleys, the activation of the motor can shorten (or lengthen) the loop of the main belt, control the tension in the belt loop, and consequently control the force pulling upward on the third pulley to actuate the joint. The actuation can be used to provide actuation for a shoulder, an ankle, knee, elbow, wrist, or other joint.

Many conventional exoskeletons feature mechanical systems that are bulky, heavy, difficult to use, and lead to large penalties for metabolic cost of transport. For example, some actuation strategies require compression sheaths and rigid structures to maintain compressive reaction forces, which increase the overall weight of the system, add nonlinear effects in the force transmission, and decrease controllability.

By contrast, the assistive devices described in this specification can include active components designed to be placed one side of the joint and a passive guide member to be arranged on or coupled to the other side of the joint, which makes the devices lightweight and comfortable to wear. For example, when used to assist movement of an ankle, the guide member can be a pulley coupled to the back of the wearer's foot (e.g., attached to a shoe). Above the ankle, along the wearer's leg, an upper attachment portion can include a differential pulley drum that can wind a belt looped about the lower pulley to pull up on the back of the foot and actuate the ankle. In this case, the motor, the differential pulley drum, the battery, the control electronics, the sensors, and other components can be placed at the upper shin, while the pulley is coupled to a wearer's shoe. This places most of the mass of the actuation system, and especially the heaviest components such as the motor assembly and the differential pulley drum, relatively high on the body (e.g., less distal). This placement provides good metabolic efficiency and comfort, since efficiency decreases the further down the leg the mass of the device is placed. The assistive device can also feature a flexible sleeve with a spring, allowing for substantially low profile and flexible form factor that can conform to the body and minimize slack in the belt that transmits force to actuate the joint.

Another disadvantage of some prior exoskeletons is the use of artificial joint components (e.g., hinges) in addition to the wearer's biological joints in order to guide actuation in the desired plane of movement. Hinges and other artificial joint elements can restrict the freedom of movement of the wearer in directions other than the direction in which the joint is being actuated, making movement feel more awkward and unnatural to the wearer. As an example, the ankle is able to move in multiple ways, e.g., flexion/extension, inversion/eversion, and internal/external rotation. Devices that use a hinge or rigid connection around the ankle to provide flexion/extension movement often have the undesirable effect of restricting inversion/eversion and internal/external rotation of the foot.

The assistive device described in this specification can use the joint of the wearer's body without adding a separate, artificial joint. As a result, the device can provide powered actuation of the joint of at least one type, while not interfering with or restricting other natural movements of the patient's joint. For example, when used with the ankle, the guide member can be coupled to the back of the wearer's foot, and a loop around the guide member allows the device to pull up on the back of the foot. The tension that the device provides can actuate the wearer's biological joint, the ankle, by transmitting force along a flexible element, such as a belt, that forms the loop. The arrangement allows transmission of force and actuation of the ankle without bulky or restrictive components hindering other natural movement of the ankle. The assistive device can induce plantarflexion and/or dorsiflexion (e.g., flexion and extension of the ankle) without restricting inversion and eversion (e.g., side-to-side movements that roll the sole of the foot medially and laterally) and without restricting medial and lateral rotation of the ankle (e.g., internal rotation and external rotation).

In a first aspect, there is provided an actuator for an assistive device including: an upper attachment portion and a lower attachment portion, a first drive pulley drum coupled to the upper attachment portion, the first drive pulley drum having a motor housed in the pulley drum, the first drive pulley drum having a first diameter, a second drive pulley drum coupled to the upper attachment portion, wherein the second drive pulley drum is coupled to the motor with a mechanical linkage configured to rotate the second drive pulley drum, the second drive pulley drum having a second diameter that is smaller than the first diameter of the first drive pulley drum, an idler pulley drum coupled to the lower attachment portion, and a belt that forms a loop by extending from the first drive pulley drum at the upper attachment portion, around the idler pulley drum in the lower attachment portion, and onto the second drive pulley drum in the upper attachment portion, where (i) activating the motor to rotate in a first direction causes the belt to be wound onto the first drive pulley drum and to be wound off the second drive pulley drum, and (ii) activating the motor to rotate in a second direction causes the belt to be wound off the first drive pulley drum and to be wound onto the second drive pulley drum.

In some implementations, the first drive pulley drum has a first axis of rotation, and wherein the second drive pulley drum has a second axis of rotation that is offset from and substantially parallel to the axis of rotation of the first drive pulley drum.

In some implementations, the first drive pulley drum has a first axis of rotation, and wherein the second drive pulley drum has a second axis of rotation that is aligned with and substantially parallel to the axis of rotation of the first drive pulley drum.

In some implementations, the actuator is configured such that (i) activating the motor in the first direction shortens a length of the belt in the loop to reduce a distance between the upper attachment portion and the lower attachment portion, and (ii) activating the motor in the second direction lengthens the length of the belt in the loop to increase a distance between the upper attachment portion and the lower attachment portion.

In some implementations, the belt has a width and a thickness, and the width of the belt is more than twice the thickness of the belt.

In some implementations, the mechanical linkage between the motor and the second drive pulley drum comprises a second belt that connects a spindle of the motor with the second drive pulley drum.

In some implementations, the motor spindle has a first drive pulley portion to engage the second belt, the first drive pulley portion having a first drive pulley portion diameter, the second drive pulley drum has a second drive pulley portion to engage the second belt, and a second drive pulley portion diameter is substantially the same as the first drive pulley portion diameter.

In some implementations, the motor spindle has a first drive pulley portion to engage the second belt, the first drive pulley portion having a first drive pulley portion diameter, the second drive pulley drum has a second drive pulley portion to engage the second belt, and a second drive pulley portion diameter is different from the first drive pulley portion diameter.

In some implementations, the second drive pulley portion diameter is one half of the first drive pulley portion diameter.

In some implementations, the motor and the second drive pulley drum are coupled with a speed ratio of substantially 1:1.

In some implementations, the mechanical linkage between the motor and the second drive pulley drum comprises one or more gears that couple the motor with the second drive pulley drum.

In some implementations, the belt has a width that is oriented in a medial-lateral direction.

In some implementations, the actuator further includes a flexible sleeve that extends between the upper attachment portion and the lower attachment portion, wherein the belt extends through the flexible sleeve.

In some implementations, the actuator further includes a resilient element located within the flexible sleeve.

In some implementations, the resilient element is a compression spring and the belt extends through the compression spring.

In some implementations, the resilient element is a die spring and the belt extends through the die spring.

In some implementations, the resilient element is made of metal, thermoplastic, or polymer.

In some implementations, the resilient element has a circular cross-section perpendicular to a longitudinal axis of the resilient element.

In some implementations, the resilient element has a rectangular cross-section perpendicular to a longitudinal axis of the resilient element.

Particular implementations of the subject matter described in this disclosure can be implemented so as to realize, but are not required to realize, one or more of the following advantages. For example, the assistive device can have a low profile, in that it extends only a small distance outward from the wearer's body (e.g., a maximum of no more than 1-3 inches in some implementations). The assistive device can be flexible, compliant, lightweight, and comfortable to avoid interfering with the wearer's natural movements. Even with these characteristics, the device can provide powered assistance to perform certain natural movements of the wearer's body without unduly restricting other movements of the same joint. Further, the device may actuate a biological joint of the wearer without the need for any artificial joints (e.g., hinges) on or around the wearer's biological joint. Further, the device can freely conform to the curves of the wearer's body (e.g., at sides located along the wearer's body), due to the flexible connecting elements between the upper pulley drums and lower guide pulley (e.g., elements such as a belt, a spring, a fabric sheath, etc.). The design is highly customizable, allowing devices to be designed with different pulley drum sizes and size ratios in order to achieve different operating characteristics. Even after manufacturing, the assistive device can be customized to change the force transmission characteristics by replacement of drive pulley drums or connecting pulleys or gears.

As will be discussed further below, the assistive device can use a belt extending from two drums of a differential pulley or split windlass. The use of a belt can increase stability and limit twisting along the length of the device. For example, if a device uses a loop cable or cord having a substantially round cross-section, the cable or cord does not provide resistance to twisting along the cable or cord. This increases the likelihood of undesired twisting of the device along its length, as well as wear or abrasion of the cable or cord. However, using a belt provides a cross-section with a width several times greater than the height or thickness of the belt. The width of the belt resists twisting and also reduces contact and wear during operation, increasing stability and longevity of the assistive device. Using a belt can provide other advantages, such as the ability to wrap the belt about itself on the differential pulley drums and keep the profile of the device low. In addition, the motor can be housed within one of the pulley drums to minimize the size of the device.

The details of one or more implementations are set forth in the accompanying drawings and the description. Other features, aspects, and advantages of the subject matter will become apparent from the description, the drawings, and the claims.

### BRIEF DESCRIPTION OF THE DRAWINGS

FIG. 1A illustrates a human wearing an example assistive device arranged to assist movement of an ankle joint.

FIG. 1B illustrates a human wearing the example assistive device of FIG. 1A arranged to assist movement of a knee joint.

FIG. 2A illustrates a medial view of the example assistive device of FIG. 1A.

FIG. 2B illustrates a rear view of the example assistive device of FIG. 1A.

FIG. 2C illustrates a lateral view of the example assistive device of FIG. 1A.

FIG. 3A illustrates a cross-section of a flexible sleeve for the example assistive device of FIG. 1A.

FIG. 3B illustrates a cross-section of another flexible sleeve for the example assistive device of FIG. 1A.

FIG. 4A illustrates a side view of another example assistive device.

FIG. 4B illustrates a rear view of the example assistive device of FIG. 4A.

Like reference numbers and designations in the various drawings indicate like elements.

### DETAILED DESCRIPTION

The present application describes assistive devices that can apply force to help actuate a joint of a wearer. The assistive devices can be exoskeletons, exosuits, or other devices that provide powered assistance to the wearer. The devices can include powerful actuators that are more flexible and versatile than typical exoskeletons that use rigid components along the wearer's body. For example, the assistive devices described below can have a resilient or even compressible material along their length, and can have a sufficiently low profile to be worn under or integrated with clothes.

Many current exoskeleton systems often rely on rigid components that mimic the skeletal structure of the wearer in order to transmit forces and torques. This often results in bulky designs that are uncomfortable and do not conform to the wearer's body. Soft exoskeletons or exosuits use fabrics to transmit forces and torque, rather than relying on rigid components, resulting in a more form-fitting design. Nevertheless, many soft, muscle-like actuators (e.g. pneumatic actuators, thermo-mechanical actuators, and electrostatic actuators) provide lower output force, speed of movement, and efficiency compared to the more rigid conventional actuation solutions. Other tendon-like actuators require a bulky and expensive transmission, such as a high-transmission-ratio planetary gear train, to drive a spool that pulls tendon-like cords to create forces on the desired body segment.

The technology described herein provides actuators that provide high torque and high efficiency, with a very low profile (e.g., remaining close to the wearer's body) and a flexible, conforming construction. The actuators can be implemented without traditional gear-based transmissions, and without the need for special transmission cables (e.g., compression sheaths, Bowden cables, etc.). The actuators can also increase comfort and efficiency using lightweight components, with the majority of the weight of the actuator being placed proximally to the joint being actuated. For example, for an assistive device used to assist knee movement, the battery and motor can be placed at the top of the actuator, while force is transferred using a lightweight transmission system, such as a thin belt that extends around a pulley below the knee. Other components along the length of the actuator can be very lightweight, such as a fabric sheath and a resilient element, such as a spring, that extend around the belt.

The actuator used can be a unidirectional belt actuator using a differential windlass transmission. Windlass transmissions provide a high rotary-to-linear transmission ratio with low part count. In a windlass transmission, the effective radius (e.g., the mapping between drum rotation and linear belt displacement) can approach zero, allowing for incredibly high linear forces to be applied. By contrast, traditional spool actuators (e.g., a single drum with a single cable) have a lower limit on the effective radius of the drum, which is dictated by the strength of the drum material and the tension forces in the cable. The differential windlass of actuators described below is implemented using two stacked pulley drums, e.g., with one pulley drum above the other, with offset axes of rotation. This feature provides increased versatility and ability for smaller size than a windlass having both drums on the same axis. For example, instead of using a single dual-diameter pulley, an actuator can use two smaller stacked pulley drums that can be linked mechanically, for example with a small toothed belt or other connection. The actuator can also use a tendon belt instead of a cable to transfer force between pulleys, which reduces complexity by simplifying housing geometry and lowering part count by avoiding the need to precisely route a cable into helical pulley groves. The use of a belt instead of a cable also allows for more compact winding, e.g., with concentric windings overlying each other in a “jelly roll” style winding rather than a helical cable winding with laterally-placed windings. The form factor of the belt, e.g., having a cross-section with a width that is several times larger than the depth, also helps resist twisting and buckling in unloaded tension.

The actuator can effectively convert the rotation of pulley drums into actuation of a joint of a wearer's body. By setting the radius of a first drive pulley drum relative to the radius of a second drive pulley drum appropriately, the linear-to-rotary transmission can be customized, which allows to accommodate different joints of a wearer's body, body types, and force delivery requirements. The heaviest components of the actuator, such as the motor assembly, can be placed relatively high on the body (e.g., less distal), thereby reducing the leverage metabolic cost of transport. The windlass, comprising a first drive pulley drum and a second drive pulley drum, can be coupled with a belt that forms a loop around an idler pulley drum. The belt extends within a flexible sleeve which allows the actuator to conform to the contours of a wearer's body and minimize slacking of the belt. The first drive pulley drum and the second drive pulley drum can each have a separate axis of rotation, which increases the versatility in placing the pulley drums and can reduce the overall size of the actuator. Because the belt can have a substantially flat form factor, it can effectively resist twist and buckling under unloaded tension.

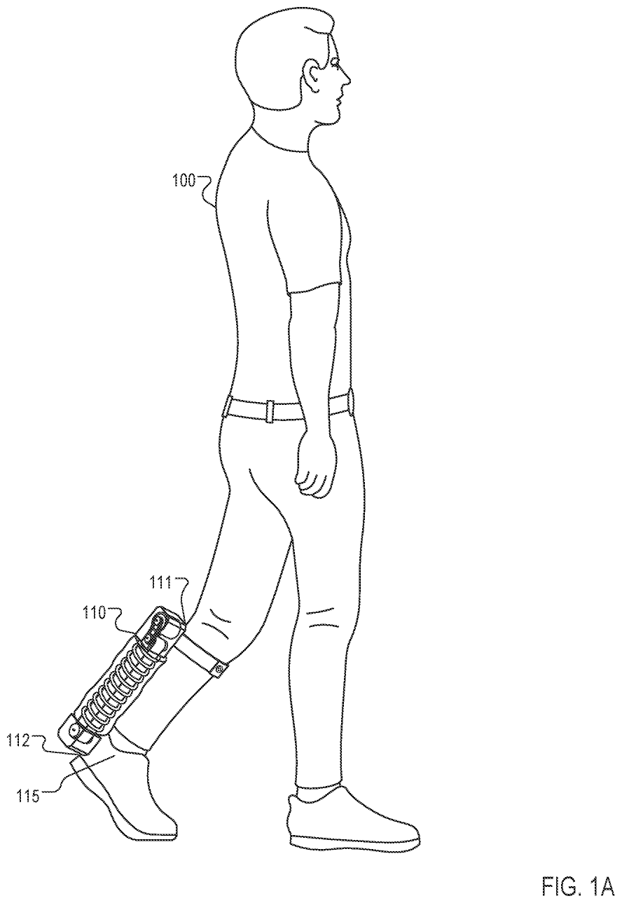

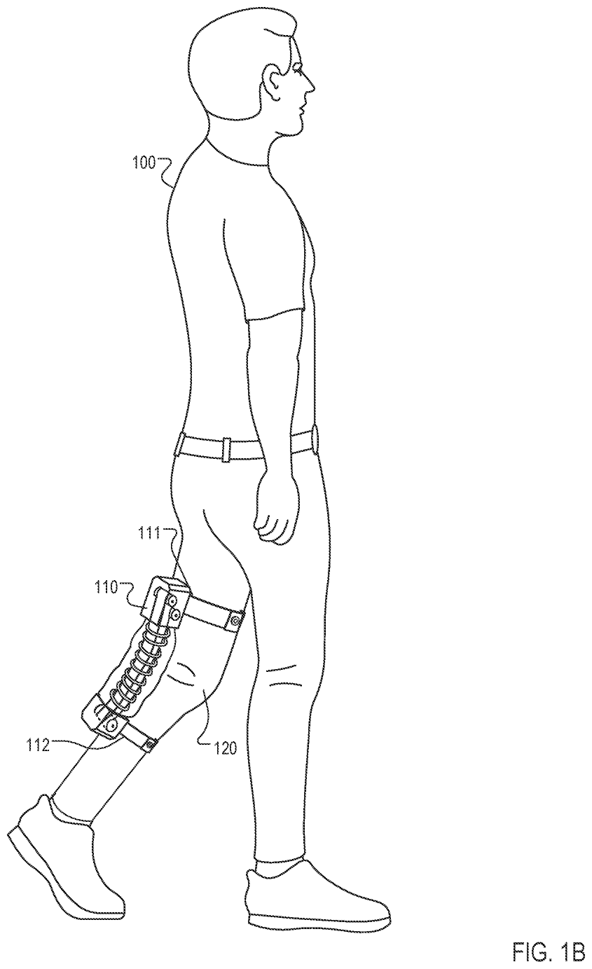

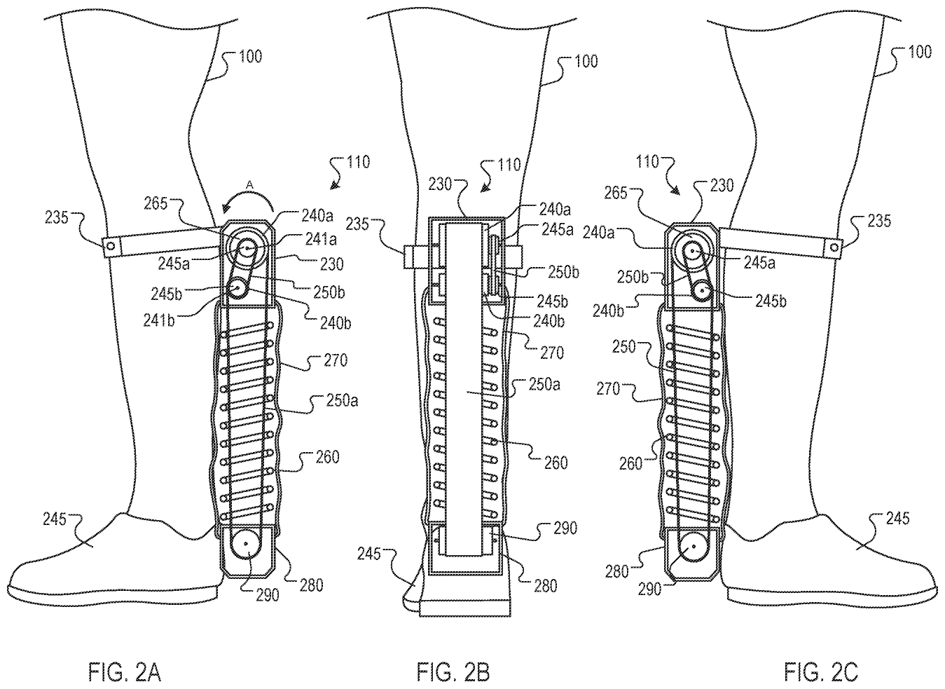

FIG. 1A shows a person (referred to as wearer 100) wearing an example assistive device 110. The components of the assistive device 110 are described in detail below with reference to FIGS. 2A, 2B, and 2C. In FIG. 1A, the assistive device 110 is shown being worn on the lower limb, in order to assist the wearer 100 with the actuation of the ankle 115 joint during walking. The assistive device 110 has an upper attachment portion 111 that couples to the lower leg of the wearer 100, for example, with a strap, belt, or cuff placed on the lower leg. The assistive device 110 has a lower attachment portion 112 that couples to the foot of the wearer 100, such as to a shoe or an insole or insert for a shoe. The assistive device 110 includes a powered transmission system to adjust the tension between the upper attachment portion 111 and the lower attachment portion 112. For example, the assistive device 110 includes a motor, a battery, and a pulley-based transmission to apply force that increases tension between the upper attachment portion 111 and the lower attachment portion 112, which pulls upward to deliver torque to the wearer's ankle 115 to induce plantar flexion of the foot (extension of the ankle) at each step. As the wearer 100 walks, the assistive device 110 increases tension and contracts to promote plantar flexion, then decreases tension to allow elongation as dorsiflexion is needed.

The actuator shown in the assistive device 110 is a unidirectional actuator, so the arrangement shown in FIG. 1A provides powered assistance to promote plantar flexion, but not to assist dorsiflexion. Nevertheless, the assistive device 110 can also be used to assist dorsiflexion of the ankle 115 if placed at the front of the leg, where increasing tension would pull upward on the front of the foot rather than on the heel of the foot. Two actuators can be used, one in front and another behind the ankle 115, to assist both plantar flexion and dorsiflexion.

The assistive device 110 can include sensors and a control system to align the forces applied with the wearer's gait. As a result, the assistive device 110 can provide help the wearer 100 walk with reduced effort and increased stability. While the figures emphasize the components of the actuator mechanism, the assistive device 110 can additionally include other elements and control systems not illustrated. In addition, multiple of the actuators can be used, for example, with another assistive device 110 used on the other leg of the wearer 100 to actuate the other ankle, or with assistive devices used to assist movement of other joints.

As will be discussed further below, the assistive device 110 uses the coordinated rotation of two pulley drums, a first drive pulley drum and a second drive pulley drum located near the upper attachment portion 111, to adjust tension in a belt looped about an idler pulley drum near the lower attachment portion 112. The applied tension in the belt can actuate the joint of the wearer 110, which is an ankle in the example of FIG. 1A. By adjusting the ratio of diameters of the first drive pulley drum and second drive pulley drum, and/or by adjusting the speed ratio for rotation of the first drive pulley drum and second drive pulley drum, the characteristics of the assistive device 110 can be set as needed for different applications. For example, by changing the radius of the first drive pulley drum relative to the second drive pulley drum (e.g., by substituting a part with a different radius), the rotary-to-linear transmission can be customized to suit a particular joint.

The pulley-based transmission system provides a lower profile (e.g., smaller size) than other options, such as a single differential pulley drum having a single axis of rotation. For example, the first and second drive pulley drums can each have a separate axis of rotation but can be mechanically linked to rotate together at a desired rate. This facilitates a more compact form factor, allowing the components of the assistive device 110 to conform freely to the wearer's body, making the assistive device 110 more comfortable to wear over or under clothes, especially for extended periods of time or for everyday use.

FIG. 1B shows the wearer 100 wearing the example assistive device 110 arranged to actuate the wearer's knee joint 120 during walking. For example, the assistive device 110 in FIG. 1B may contract to deliver torque to the knee 120 to induce flexion of the knee 120 at each step. The upper attachment portion 111 is placed above the knee 120, and the lower attachment portion 120 is placed below the knee 120. At an appropriate time in the wearer's gait, the control system for the assistive device 110 can increase tension to initiate extension of the knee 120, and then also reduce tension to permit extension during the wearer's gait.

In the example of FIG. 1B, the assistive device 110 delivers torque to a knee joint 120, which has a much higher range of flexion than the ankle 115. Advantageously, the pulley drums that provide rotary-to-linear transmission of force in the assistive device 110 can be customized to meet the needs of the knee 120. Along the length of the assistive device 110, the flexible sleeve, the internal belt, and other components can freely bend and conform to the body, even when the knee 120 is flexed to a high degree (e.g., to approximately 140 degrees).

The actuator shown in the assistive device 110 is a unidirectional actuator, so the arrangement shown in FIG. 1B provides powered assistance to promote extension, but not to assist flexion. Nevertheless, the assistive device 110 can also be used to assist flexion of the knee 120 if placed at the front of the leg, where increasing tension would promote flexion instead of extension. Two actuators can be used, one at the front of the knee 120 and another at the back of the knee 120, to assist both flexion and extension. Similarly, the actuators can be used for either or both knees of the wearer.

While the assistive device 110 illustrated in FIGS. 1A and 1B is shown as being worn on the lower limb, the assistive device 110 can be used to assist and actuate movement of other joints of both the upper and the lower body such as, but not limited to, an elbow joint, a shoulder joint, a wrist joint, a finger joint, etc.

As discussed further below, the assistive device 110 includes a first drive pulley drum and a second drive pulley drum coupled to an upper attachment portion which may be placed on the wearer's body at one side of the joint, and an idler pulley drum coupled to a lower attachment portion which may be placed on the other side of the joint. The active components of the device, e.g., the motor, can be coupled to the upper attachment portion in both implementations. The first drive pulley drum, the second drive pulley drum, and the idler pulley drum can be connected with a belt that can extend from the upper attachment portion to the lower attachment portion thereby forming a loop. Another example assistive device 410, discussed further below, can include these same features.

In the assistive device 110, in the assistive device 110, the first drive pulley drum and the second drive pulley drum can be coupled with a speed ratio of 1:1, with differential winding of a belt being provided by different diameters of the first drive pulley drum and the second drive pulley drum. By contrast, in the assistive device 410, the first drive pulley drum and the second drive pulley drum are not coupled with a 1:1 speed ratio, and differential winding of a belt is provided by differences in the speed ratio. For example, in the assistive device 410, the first drive pulley drum and second drive pulley drum can have, but are not required to have, the same diameter. The connection of the first drive pulley drum and second drive pulley drum can set a speed ratio of 1:x, where x is a predetermined value that can be greater than or less than 1. The value of x can be set by the difference in size of drive pulley portions or gears coupled to the respective pulley drums.

FIGS. 2A, 2B and 2C show medial, rear, and lateral views, respectively, of the assistive device 110. The assistive device 110 is illustrated as being worn across an ankle joint on the leg 100 of a wearer and can be engaged to apply force to actuate the ankle joint (e.g., to induce plantar flexion).

The assistive device 110 can expand and contract to vary the force (e.g., tension) and distance between an upper attachment portion 230 and a lower attachment portion 280. The assistive device 110 applies force between the attachment portions 230, 280 powered by a motor 265. A transmission having three pulley drums applies force from the motor 265 to actuate the wearer's ankle. A first drive pulley drum 240a and a second drive pulley drum 240b are located at the upper portion of the assistive device 110. An idler pulley drum 290 is located at the lower portion of the assistive device 110. A main belt 250a links all three pulley drums, 240a, 240b, 290, to transmit force between the upper attachment portion 230 and the lower attachment portion 280. As described further below, the first drive pulley drum 240a and the second drive pulley drum 240b are coupled together with a mechanical linkage 250b so that they rotate together. The first drive pulley drum 240a and the second drive pulley drum 240b have different diameters, so that driving the motor 265 in one direction increases tension and contracts the assistive device 110, and driving the motor 265 in the opposite direction decreases tension and allows the assistive device 110 to elongate. The difference in diameters of first drive pulley drum 240a and the second drive pulley drum 240b sets the transmission ratio for the assistive device 110.

In further detail, the transmission includes a first drive pulley drum 240a and a second drive pulley drum 240b, which are coupled by a mechanical linkage 250b so that they rotate together with a predetermined relationship. The first drive pulley drum 240a has a different radius from the second drive pulley drum 240b. For example, the radius of the first drive pulley drum 240a may be larger than the radius of the second drive pulley drum 240b. The first drive pulley drum 240a has a first axis of rotation 241a, and the second drive pulley drum 240b has a second axis of rotation 241b that is offset from and substantially parallel to the first axis of rotation 241a of the first drive pulley drum 240a. The axes 241a, 241b can be offset from each other to provide clearance to accommodate the expansion of the effective diameter of the pulley drums as the main belt 250a wraps around them. For example, the axes 241a, 241b can be offset from each other along the superior-inferior axis and along the anterior-posterior axis so that the pulley drums 240a, 240b, when wrapped with a maximum length of the belt 250a expected for the design, will still not contact the other pulley drum or the housing, and will not cause the loop of the main belt 250 to contact the interior of the resilient element 260.

The main belt 250a has a portion wound around each of the first drive pulley drum 240a and the second drive pulley drum 240b. The main belt 250a extends downward from each of the first drive pulley drum 240a and the second drive pulley drum 240b where the belt 250a forms a loop around the idler pulley drum 290.

The motor 265 is housed inside the first drive pulley drum 240a, which helps minimize the space required for the assistive device 110. The spindle of the motor 265 is connected to and has a common axis of rotation 241a with the first drive pulley drum 240a. When the motor 265 is engaged to rotate in a first direction (shown by arrow A), it rotates the first drive pulley drum 240a in that direction, which causes the main belt 250a to be wound onto the first drive pulley drum 240a.

The main portion of the first drive pulley drum 240a engages the main belt 250a. The first drive pulley drum 240a is coupled to a first drive pulley portion 245a that engages the secondary belt 250b. The first drive pulley portion 245a is rigidly affixed to the first drive pulley drum 240a so that the first drive pulley drum 240a and the first drive pulley portion 245a rotate together as a unit about a common axis 241a. As illustrated, the first drive pulley portion 245a has a different diameter than the first drive pulley drum 240a. In some implementations, the first drive pulley portion 245a is a gear or a grooved or ridged drum to engage a toothed belt.

Similarly, the main portion of the second drive pulley drum 240b engages the main belt 250a. The second drive pulley drum 240a is coupled to a second drive pulley portion 245b that can engage the secondary belt 250b. The second drive pulley portion 245b is rigidly affixed to the second drive pulley drum 240b so that the second drive pulley drum 240b and the second drive pulley portion 245b rotate together as a unit about a common axis 241b. As illustrated, the second drive pulley portion 245b has a different diameter than the second drive pulley drum 240b. In some implementations, the second drive pulley portion 245b is a gear or a grooved or ridged drum to engage a toothed belt.

The mechanical linkage 250a connects the first drive pulley drum 240a and the second drive pulley drum 250b so that the motor 265 causes both pulley drums 240a, 240b to rotate. The mechanical linkage 250b can be a toothed secondary belt or drive belt that engages portions of the first drive pulley drum 240a and the second drive pulley drum 240b. The mechanical linkage 250b engages the drive pulley portions 245a, 245b to cause the first drive pulley drum 240a and the second drive pulley drum 240b to rotate together. Thus, as the motor spindle turns the first drive pulley drum 240a, the affixed first drive pulley portion 245a also turns in the same direction. The mechanical linkage 250b, e.g., a secondary belt 250b engaged with the first drive pulley portion 245a and the second drive pulley portion 245b, then causes the second drive pulley drum 240b to rotate also.

The mechanical linkage 250b that couples the motor 265 to the second drive pulley drum 240b can be any appropriate element, e.g., a cable, a belt, a strip, a strip, a string, a filament, a thread, etc. In some implementations, the first drive pulley portion 245a and second drive pulley portion 245b can each include one or more gears, which both engage a belt to cause a rotation of the second drive pulley drum 240b that corresponds to the rotation of the first drive pulley drum 240a driven by the motor 265.

The drive pulley portion 245a of the first drive pulley drum 240a and the drive pulley portion 245b of the second drive pulley drum 240b can have substantially the same diameter. In this manner, when the motor 265, housed in the first drive pulley drum 240a, is engaged to rotate the first drive pulley drum 240a, it can cause a corresponding amount of rotation of the second drive pulley drum 240b by means of the secondary belt 250b and the drive pulley portions 245a, 245b. When the drive pulley portions 245a, 245b have substantially the same diameter, the first drive pulley drum 240a and the second drive pulley drum 240b are coupled with a speed ratio of substantially 1:1. As a particular example, the speed of rotation of the motor 265 can be plus or minus 10% of the speed of the second drive pulley drum 240b.

Accordingly, when the motor 265 is engaged to rotate the pulley drum 240a in one direction (e.g., the direction of arrow A in FIG. 2A) which winds some of the main belt 250a onto the pulley drum 240a, the mechanical linkage 250b causes the second drive pulley drum 240b to rotate in the same direction, which causes some of the main belt 250a to be wound off the second drive pulley drum 240b. Because the first drive pulley drum 240a has a larger diameter than the second drive pulley drum 240b, even though both pulley drums 240a, 240b rotate at substantially the same rate, rotation in this direction reduces the length of the main belt 250a that is in the loop. When the loop of the main belt 250a is shortened, the force in the main belt 250a is converted to a linear motion of the lower attachment portion 280 towards the upper attachment portion 230, thereby causing extension of the ankle.

By contrast, when the motor 265 is engaged to rotate the pulley drum 240a in the opposite direction (e.g., opposite the direction of arrow A), some of the main belt 250a is wound off the first drive pulley drum 240a. At the same time, the mechanical linkage 250b causes the second drive pulley drum 240b to rotate in the same direction, causing some of the main belt 250a to be wound onto the second drive pulley drum 240b. Because the first drive pulley drum 240a has a larger diameter than the second drive pulley drum 240b, this rotation winds the main belt 250a off the first drive pulley drum 240a faster than the main belt 250a is wound onto the second drive pulley drum 240b, which increases the length of the main belt 250a that is in the loop. The increase in length of the loop reduces tension and allows the ankle to flex.

The main belt 250a can wrap radially around the first drive pulley drum 240a and the second drive pulley drum 240b. Furthermore, the main belt 250a can have a width and a thickness, with the width being more than twice the thickness. Furthermore, the width of the main belt 250a can be oriented in a medial-lateral direction. Therefore, the main belt 250a can resist twist and actuator buckling under unloaded tension. Furthermore, the main belt 250a can have a relatively flat form factor, thereby simplifying the overall geometry of the assistive device 110 and making it comfortable to wear.

The upper attachment portion 230 can include a housing that is configured to house the first drive pulley drum 240a, the second drive pulley drum 240b, their respective drive pulley portions 240a, 245b, and the motor 265. The housing can further include a position encoder coupled to, or integrated with, the motor 265, which may determine a position of the motor 265 or a component coupled to the motor 265. The housing may also include a load sensor integrated with the motor 265 and coupled to the main belt 250a. The upper attachment portion 230 can be coupled to a strap 235 placed on one side of the joint and configured to hold the assistive device 110 on the leg 100 of a wearer via frictional forces. The active components handling power and data (the motor 265 with integrated load cell and position encoder, the first drive pulley drum 240a, and the second drive pulley drum 240b) may be arranged in the housing that is substantially flat, so that they lay flat against the leg 100 to minimize protrusion.

As described above, in addition to the first drive pulley drum 240a and the second drive pulley drum 240b, the assistive device 110 can also include the idler pulley drum 290. The main belt 250a can form a loop by extending from the first drive pulley drum 240a at the upper attachment portion 230, around the idler pulley drum 290 in the lower attachment portion 280, and onto the second drive pulley drum 240b in the upper attachment portion 230. The idler pulley drum 290 can be included in a housing coupled to the lower attachment portion 280 that can be arranged on the other side of the joint (e.g., on the other side of the ankle joint, as shown in FIG. 1). The housing of the lower attachment portion 280 may also lay flat against the body to minimize protrusion.

Because the main belt 250a has a substantially flat and compact form factor winding radially around the first drive pulley drum 240a, the second drive pulley drum 240b, and the idler pulley drum 290, and the components of the assistive device 110 are arranged in such a way so as to minimize protrusion with respect to the leg 100, the assistive device 110 may overall have a substantially low profile and be comfortable to wear. Since the active components are arranged on one side of the joint with only the idler pulley drum 290 on the other, the distal mass may be reduced, which has larger penalties for metabolic cost of transport. The lower attachment portion 280 may be coupled to the shoe 245 of the wearer and may consist of a relatively stiff component so as to minimize the deformation of the shoe 245 in response to the applied force and maximize the effective mechanical work delivered to the ankle.

The assistive device 110 can further include a flexible sleeve 270 extending between the upper attachment portion 230 and the lower attachment portion 280 (e.g., extending from one side of the joint to the other side of the joint). The sleeve 270 may be made from a substantially flexible material, such as fabric, so that it is able to bend and freely conform to the curves of the leg 100. As illustrated in FIGS. 2A, 2B, and 2C, the axis of rotation of the first drive pulley drum 240a, the second drive pulley drum 240b, and the idler pulley drum 290, can be substantially perpendicular to the longitudinal axis of the flexible sheath 270.

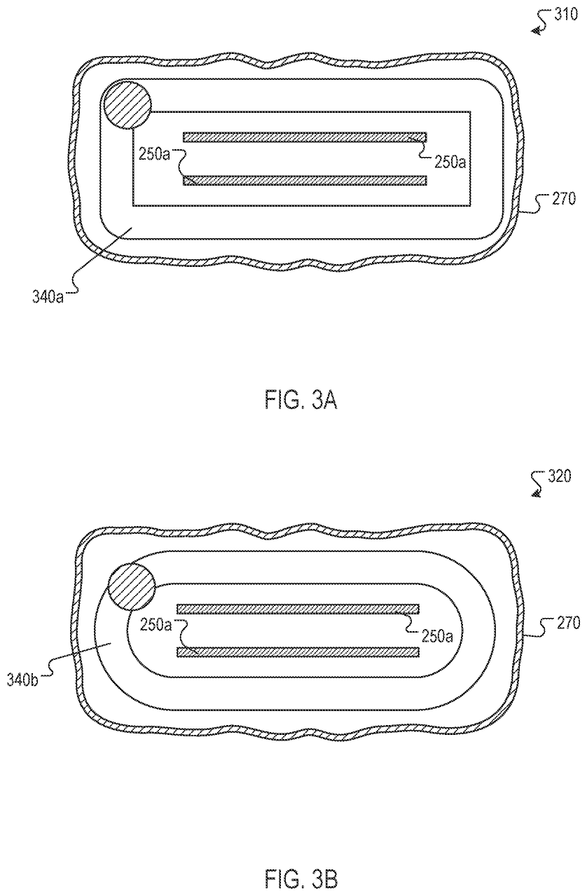

The assistive device 110 may further include a resilient element 260 extending from the first attachment portion 230 to the second attachment portion 280, and positioned within the flexible sleeve 270. The resilient element may be a spring, or any other element capable of storing elastic energy, and it may be made of metal, or fatigue resistant thermoplastic. The resilient element 260 may be coupled to the main belt 250a (e.g., the main belt 250a may extend through the resilient element 260 in the flexible sleeve 270) and it may apply compressive force to the main belt 250a between the first attachment portion 230 and the second attachment portion 280 to maintain the belt 250a under tension. In this way, the belt 250a may be easily kept taught to avoid snagging, and arranged closer to the body to avoid protrusion, allowing for substantially low profile and convenience of wear of the assistive device 110. Different configurations of the flexible sleeve 270, the resilient element 260, and the main belt 250a will be described in more detail below with reference to FIGS. 3A and 3B.

As described above, the main belt 250a can form a loop by extending from the first drive pulley drum 240a at the upper attachment portion 230, around the idler pulley drum 290 in the lower attachment portion 280, and onto the second drive pulley drum 240b in the upper attachment portion 230. The motor 265 may rotate the first drive pulley drum 240a and the second drive pulley drum 240b to increase tension in the main belt 250a (e.g., to shorten the loop of the belt 250a) which may transmit force to the biological joint (e.g., ankle joint, in the implementation shown in FIGS. 2A, 2B, and 2C) and thereby actuate it. In other words, when the motor 265 rotates the pulley drums 240a, 240b, the main belt 250a moves along the third pulley 290 and tension increases. The tension in the belt 250a is transmitted to the foot as an upward force at the heel where the idler pulley drum 290 is attached. The force translates into a torque of the ankle joint such that the heel moves upward in the direction of the force and the toes of the foot move in the opposite direction. Since the belt 250a is arranged as a loop around the idler pulley drum 290, the joint may move freely out of the main plane of actuation. For example, ankle plantar flexion may be applied lifting the heel while not affecting the foot ability to move freely in the yah and roll axis.

In some implementations, the idler pulley drum 290 may be a rolling wheel pulley, such that the belt 250 is able to travel along with the rolling wheel. The axis of rotation of the idler pulley drum 290 may be substantially parallel to the axis of rotation of the joint. In some implementations, the idler pulley drum 290 may be a guide pulley with a channel, such that the main belt 250a is able to slide in the channel. The guide may be made using low friction plastic such as, but not limited to, ultra-high molecular weight polyethylene (UHMWPE) plastic. The main belt 250a may slide in the slippery plastic groove of the guide pulley. Having a passive pulley transmitting force to the biological joint negates the need for mechanically powered artificial joints, which significantly minimizes the overall physicality of the assistive device 110.

The assistive device 110 may include a high-level controller, which may determine the type of movement or assistance to provide to the user. The assistive device 110 can also include a low-level controller that determines how the assistance is achieved, such as translating general motion or assistance instructions to specific motor control signals. For example, the low-level controller may repeatedly determine the desired force to be applied to the main belt 250a over time to apply force when needed to assist the user's movement and to otherwise maintain a desired level of tension (e.g., avoid slack in the belt 250a). The assistive device 110 can use encoders, position sensors, force sensors, accelerometers, gyroscopes, inertial measurement units, and/or other sensors to measure the current situation of the assistive device 110, e.g., position of the assistive device 110, torque applied by the motor 265, tension in the belt 250a, and so on. In response to the measurements, the low-level controller may send a signal to the motor 265 to rotate the first drive pulley drum 240a and the second drive pulley drum 240b and thereby shorten or lengthen the loop of the main belt 250a as needed to provide the appropriate level of assistance or to take up slack in the main belt 250a as needed. In this way, the active components of the assistive device may form a closed control feedback loop. The assistive device 410 discussed below can include the same types of sensors and controllers.

FIGS. 3A and 3B illustrate cross-sectional views of two different versions 310, 320 of components that extend around the main belt 250a, e.g., the resilient element 260 and flexible sleeve 270. The assistive device 110 can use either version 310, 320 of the spring and sheath.

FIG. 3A illustrates a cross-sectional view of a first version 310 in which the resilient element 260 of FIGS. 2A-2C is a flat rectangular spring 340a. The spring 340a can have a rectangular cross-section perpendicular to the longitudinal axis of the assistive device 110. As described above, the flexible sleeve 270 can be made of a flexible material, such as fabric, and can extend around the spring 340a along the length of the spring 340a. The spring 340a can be made of metal, thermoplastic, or polymer. The main belt 250a extends through the spring 340a, which in turn extends through the flexible sleeve 270. The spring 340a can be a compression spring, or any other type of spring. For example, the spring 340a can be a flat rectangular wire (e.g., as in a die spring).

FIG. 3B illustrates a cross-sectional view of the second version, where the resilient element 260 is a flat rounded spring 340b. Rather having a substantially rectangular cross-section as shown in FIG. 3A, the cross-section of the spring 340b is oblong (e.g., rounded ends with a pair of parallel opposing sides), oval, circular, or is otherwise rounded. The rounded shape of the spring 340b, which extends along the length of the assistive device 110 (e.g., generally along the superior-inferior axis) can reduce friction and wear from contact with other objects when worn. The main belt 250a extends through the spring 340a, which in turn extends through the flexible sleeve 270. The flexible sleeve 270 may be adjusted to fit the exterior shape of the spring 340a, whether rectangular, oblong, or having another cross-sectional shape.

As another option, a corrugated thermoplastic tube can be used as the resilient element 260, and the main belt 250a can extend through the corrugated thermoplastic tube instead of through a spring and a fabric sheath. The corrugation can enable the tube to bend and deform to conform to the wearer's body, as well as to expand and contract as the main belt 250a elongates and contracts during use of the assistive device. The use of the corrugated tube may be appropriate in applications where the actuator will not undergo large bends, and so the belt 250a will not frequently contact the walls, which would cause abrasion. As a result, the corrugated tube option may be most appropriate for assistance for an ankle joint, where bending along the length of the assistive device 110 is less than for other joints, such as a knee where the angle of movement would be much greater. A fabric sheath 270 may optionally be used around the exterior of the corrugated tube.

In some implementations, additional components can be used to maintain or enhance the central opening in which the main belt 250a extends. For example, in applications where significant bend is expected along the length of the device 110, a belt support block can be positioned midway along the length of the device 110, between the main belt 250a and the resilient element 260. The belt support block can include idler pulleys or can be made of a slippery material such as ultra-high molecular weight polyethylene (UEMWPE) or Teflon to keep the main belt 250a in the middle of the resilient element 260 even during bending and to reduce belt abrasion from contact with the resilient element 260.

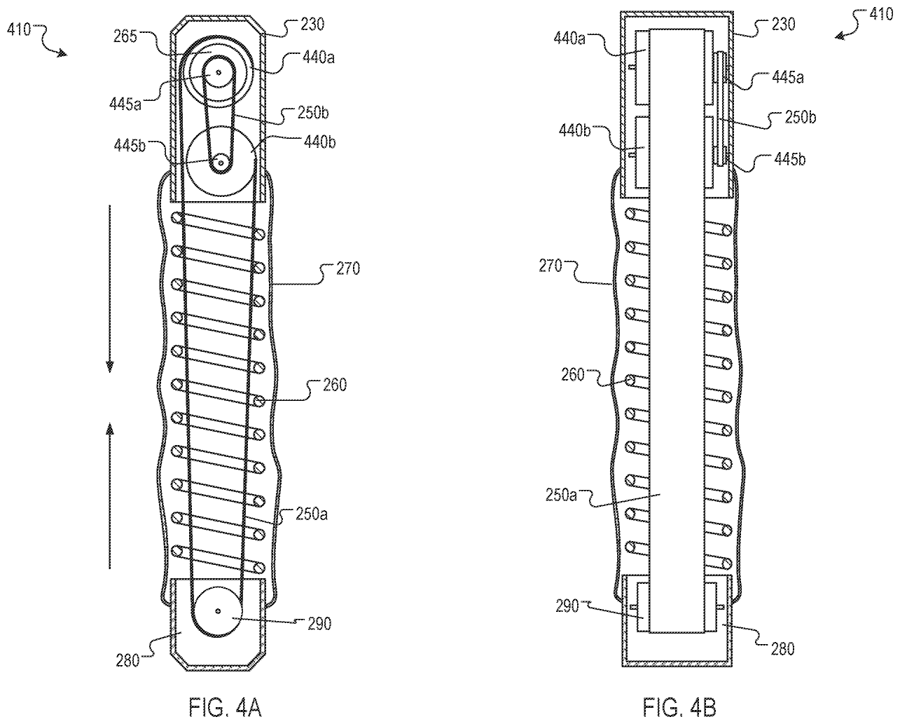

FIGS. 4A and 4B illustrate another example of assistive device 410. FIG. 4A illustrates a side view of the assistive device 410, and FIG. 4B illustrates a rear view of the assistive device 410.

The assistive device 410 has the same general components as the assistive device 110 and operates in the same manner described above, but achieves the differential winding of the drive belt 250a in a different manner. The upper attachment portion 230, the lower attachment portion 280, the motor 265, the main belt 250a, the secondary belt 250b, the resilient element 260, the flexible sleeve 470, and the idler pulley drum 290 in the assistive device 410 are the same as in the assistive device 110. However, the assistive device 410 includes pulley drums 440a, 440b and drive pulley portions 445a, 445b that have different size relationships compared to the corresponding components in the assistive device 110.

In the assistive device 110 of FIGS. 2A-2C, the differential ratio for winding the main belt 250a on the pulley drums 240a, 240b is set by the different diameters of the pulley drums 240a, 240b. The first drive pulley portion 245a and the second drive pulley portion 245b engage the secondary belt 250b, and the drive pulley portions 245a, 245b have substantially the same diameter. As a result, the secondary belt 250b that engages the drive pulley portions 245a-245b causes rotation of the pulley drums 240a, 240b at a substantially 1:1 ratio. The differential winding of the main drive belt 250a onto the pulley drums 240a, 240b is caused by the different drum diameters of the pulley drums 240a, 240b (e.g., with the first drive pulley drum 240a having a larger diameter than the second drive pulley drum 240b). In other words, the mechanical linkage provides a 1:1 connection ratio between the pulley drums 240a, 240b.

In the assistive device 410 of FIGS. 4A-4B, the differential ratio for winding the main belt 250a is set by a difference in the speed ratio for rotation of the pulley drums 440a, 440b, not by a difference in the diameters of the pulley drums 440a, 440b that engage the main belt 250a. The speed ratio is set by a difference in the diameters of the drive pulley portions 445a, 445b, while the pulley drums 440a, 440b have substantially the same diameter. This design allows a wide range of speed ratios, e.g., ratios of 1:x, where “x” is set based on the size of the second drive pulley portion 445b relative to the size of the first drive pulley portion 445a. In other words, instead of being coupled with a speed ratio of 1:1, the motor 465 and the second drive pulley drum 440b can be coupled with a speed ratio of 1:x, where x can be any appropriate number that can depend on the relative diameters of the drive pulley portion 445a of the first drive pulley drum 440a and the drive pulley portion 445b of the second drive pulley drum 440b.

In the assistive device 410, setting the differential ratio using the drive pulley portions 445a, 445b can facilitate manufacturing and maintenance. For example, rather than adjusting one or both of the pulley drums 440a, 440b to adjust the differential ratio, just the drive pulley portion 445b can be replaced to change the speed ratio for rotation of the pulley drums 440a, 440b and thus the differential ratio of winding of the belt 250a. In some implementations, the drive pulley portions 445a, 445b can each be a gear affixed to the corresponding pulley drums 440a, 440b, and the mechanical linkage 250b can be a toothed belt or a chain. Adjusting the differential ratio can be done by simply replacing one or both of the gears. Also simplifying manufacturing, the pulley drums 440a, 440b and the idler pulley drum 290 can all have the same diameter.

As shown in FIGS. 4A and 4B, the housing of the upper attachment portion 430 includes the main drive components, including the motor 265, the first drive pulley drum 440a, and the second drive pulley drum 440b. The motor 265 is housed in the first drive pulley drum 440a. The main belt 250a has a portion wound around the first drive pulley drum 440a and a portion wound around the second drive pulley drum 440b, with a loop of the main belt 250a extending down and around the idler pulley drum 290.

The first drive pulley drum 440a is rigidly coupled to and rotates with the drive pulley portion 445a that engages the mechanical linkage 450b, e.g., a secondary belt. The second drive pulley drum 440b is rigidly coupled to and rotates with the drive pulley portion 445b that also engages the mechanical linkage 250b. The drive pulley portion 445a of the first drive pulley drum 440a and the drive pulley portion 445b of the second drive pulley drum 440b have different diameters as discussed above. This makes the assistive device 410 highly customizable, since the drive pulley portion 445b (and/or the drive pulley portion 445a) can be changed in any of various ways to change the for different wearers and for various degrees of actuation of different joints in the body.

When the motor 265 is engaged, it rotates the first drive pulley drum 440a and engages the mechanical linkage 250b such that it rotates the second drive pulley drum 440b. The main belt 250a extends from the first attachment portion 230 through the resilient element 260 and the flexible sleeve 270, and towards the lower attachment portion 280. The main belt s50a extends from the first drive pulley drum 440a, around the idler pulley drum s90, and to the second drive pulley drum 440b thereby forming a loop.

In operation, the assistive device 410 performs the same functions as described above for the assistive device 110, although with a different mechanism for setting the differential winding of the belt 250a on the pulley drums. In particular, as discussed above, activating the motor w65 in the first direction shortens a length of the main belt 250a in the loop to reduce a distance between the upper attachment portion 230 and the lower attachment portion 280, and activating the motor 265 in the second direction lengthens the length of the main belt 250a in the loop to increase a distance between the upper attachment portion 230 and the lower attachment portion 280.

The controller and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments of the subject matter have been described. Other embodiments are within the scope of the following claims.

1. An actuator for an assistive device comprising:
an upper attachment portion and a lower attachment portion;
a first drive pulley drum coupled to the upper attachment portion, the first drive pulley drum having a motor housed in the pulley drum, the first drive pulley drum having a first diameter;
a second drive pulley drum coupled to the upper attachment portion, wherein the second drive pulley drum is coupled to the motor with a mechanical linkage configured to rotate the second drive pulley drum, the second drive pulley drum having a second diameter that is smaller than the first diameter of the first drive pulley drum;
an idler pulley drum coupled to the lower attachment portion; and
a belt that forms a loop by extending from the first drive pulley drum at the upper attachment portion, around the idler pulley drum in the lower attachment portion, and onto the second drive pulley drum in the upper attachment portion,
wherein (i) activating the motor to rotate in a first direction causes the belt to be wound onto the first drive pulley drum and to be wound off the second drive pulley drum, and (ii) activating the motor to rotate in a second direction causes the belt to be wound off the first drive pulley drum and to be wound onto the second drive pulley drum.

2. The actuator of claim 1, wherein the first drive pulley drum has a first axis of rotation, and wherein the second drive pulley drum has a second axis of rotation that is offset from and substantially parallel to the axis of rotation of the first drive pulley drum.

3. The actuator of claim 1, wherein the first drive pulley drum has a first axis of rotation, and wherein the second drive pulley drum has a second axis of rotation that is aligned with and substantially parallel to the axis of rotation of the first drive pulley drum.

4. The actuator of claim 1, wherein the actuator is configured such that (i) activating the motor in the first direction shortens a length of the belt in the loop to reduce a distance between the upper attachment portion and the lower attachment portion, and (ii) activating the motor in the second direction lengthens the length of the belt in the loop to increase a distance between the upper attachment portion and the lower attachment portion.

5. The actuator of claim 1, wherein the belt has a width and a thickness, and the width of the belt is more than twice the thickness of the belt.

6. The actuator of claim 1, wherein the mechanical linkage between the motor and the second drive pulley drum comprises a second belt that connects a spindle of the motor with the second drive pulley drum.

7. The actuator of claim 6, wherein the motor spindle has a first drive pulley portion to engage the second belt, the first drive pulley portion having a first drive pulley portion diameter; and
wherein the second drive pulley drum has a second drive pulley portion to engage the second belt, wherein a second drive pulley portion diameter is substantially the same as the first drive pulley portion diameter.

8. The actuator of claim 6, wherein the motor spindle has a first drive pulley portion to engage the second belt, the first drive pulley portion having a first drive pulley portion diameter,
wherein the second drive pulley drum has a second drive pulley portion to engage the second belt, and wherein a second drive pulley portion diameter is different from the first drive pulley portion diameter.

9. The actuator of claim 8, wherein the second drive pulley portion diameter is one half of the first drive pulley portion diameter.

10. The actuator of claim 1, wherein the motor and the second drive pulley drum are coupled with a speed ratio of substantially 1:1.

11. The actuator of claim 1, wherein the mechanical linkage between the motor and the second drive pulley drum comprises one or more gears that couple the motor with the second drive pulley drum.

12. The actuator of claim 1, wherein the belt has a width that is oriented in a medial-lateral direction.

13. The actuator of claim 1, further comprising a flexible sleeve that extends between the upper attachment portion and the lower attachment portion, wherein the belt extends through the flexible sleeve.

14. The actuator of claim 13, further comprising a resilient element located within the flexible sleeve.

15. The actuator of claim 14, wherein the resilient element is a compression spring and the belt extends through the compression spring.

16. The actuator of claim 14, wherein the resilient element is a die spring and the belt extends through the die spring.

17. The actuator of claim 14, wherein the resilient element is made of metal, thermoplastic, or polymer.

18. The actuator of claim 14, wherein the resilient element has a circular cross-section perpendicular to a longitudinal axis of the resilient element.

19. The actuator of claim 14, wherein the resilient element has a rectangular cross-section perpendicular to a longitudinal axis of the resilient element.
